(19) United States
(12) Patent Application Publication
(10) Pub. No.: US 2004/0221950 A1
(43) Pub. Date: Nov. 11, 2004

(54) Method of mounting glass to glass holder

(76) Inventors: Akira Mizusawa, Toyota-shi (JP); Katsuhiro Mitomi, Yokohama-shi (JP); Kouji Ichikawa, Aichi-ken (JP); Norihiko Murata, Nagoya-shi (JP)

Correspondence Address: Hauptman Kanesaka Berner Patent Agents LLP, 1700 Diagonal Road, Suite 310, Alexandria, VA, 22314, US

(21) Appl. No.: 10/861,505

(22) Filed: Jun. 7, 2004

Related U.S. Application Data
(62) Division of application No. 10/268,952, filed on Oct. 11, 2002.

(30) Foreign Application Priority Data
Oct. 16, 2001 (JP) 2001-317673

(51) Int. Cl. B32B 31/00

(52) U.S. Cl. 156/272.4

(57) ABSTRACT

A method of mounting a glass to a glass holder having a pair of holder pieces includes the steps of attaching a hot-melt resin to at least one of the holder pieces, sandwiching the glass between the holder pieces and applying a force therebetween, and applying a high-frequency dielectric heating to an area where the glass is sandwiched between the holder pieces.

### CROSS REFERENCE TO RELATED APPLICATION

This is a divisional application of a patent application Ser. No. 10/268,952 filed on Oct. 11, 2002.

### BACKGROUND OF THE INVENTION AND RELATED ART STATEMENT

The present invention relates to a method for mounting a window glass to a glass holder.

FIG. 4 is a perspective view showing a conventional glass holder 110 for supporting a window glass of an automobile and a roller guide 112 forming a mechanism for elevating and lowering the glass holder 110. A window glass 130 is fixed to the glass holder 110, and the glass holder 110 is attached to the roller guide 112 included in the elevating and lowering mechanism by using a bolt 140 or the like.

FIG. 5 is a sectional view taken along line 5-5 in FIG. 4. The window glass 130 is bonded to a portion 111 having a U-shaped section in the glass holder by an adhesive 107, such as a urethane adhesive. Also, an insert nut 109 as a mounting structure for attaching the glass holder to the roller guide is attached to a mounting section 103 of the glass holder. Therefore, as shown in FIG. 4, it is possible to attach the glass holder to the roller guide 112 by using only the bolt 140.

According to this structure, a space between the glass and the glass holder is filled with the urethane adhesive or the like, to thereby bond the glass to the glass holder, so that the glass and the glass holder can be attached to the elevating and lowering mechanism.

However, in the case of using the conventional glass holder as described above, in order to bond the glass and the glass holder firmly, it is necessary to apply a primer processing to adhering surfaces of the glass and the glass holder. Also, it takes approximately twenty-four hours to completely cure the urethane resin, and during that time, the assembling operations can not be proceeded. Therefore, the product stays in the process, resulting in lowering the productivity.

Further, a wall surface of the glass holder is required to fit with the glass properly so as to prevent the glass holder clamping the glass from falling by its own weight until the adhesive is cured. Accordingly, it is necessary to control the dimensional accuracy of the glass holder within a predetermined range as well as to keep various glass holders for the glass with various thicknesses.

Also, in order to secure the predetermined adhesion strength, it is necessary to control or manage a method of storing an adhesion primer agent and the urethane adhesive and expiration date thereof. Moreover, since the metal nut is provided by insert molding to the glass holder, many types of steps are necessary for a process of forming the glass holder, resulting in lower productivity.

In order to solve the foregoing problems, a bonding method has been proposed by using a heat foaming resin including a heating element that generates heat by high frequency induction heating as disclosed in Japanese Patent Publication (KOKAI) No. 06-206442. According to this method, the heat foaming resin is disposed between the glass holder and the glass, and the high-frequency heating is applied thereto. By the high-frequency heating, the heating element, such as an electric conductor, generates heat, and the foaming resin is foamed to thereby fill the space between the glass holder and the glass, resulting in bonding therebetween. Since this type of adhesive is thermally set, the adhesive can be cured in a short period of time, so that the product in this process is not required to be left for a long time as in the conventional method.

However, the adhesion strength of the foaming resin is not so high, thereby creating a durability problem. Namely, as compared with the adhesive formed exclusively of an adhesive after curing, more spaces may be formed in the heat foaming resin, so that the adhesion strength tends to be low.

Accordingly, an object of the invention is to provide a method of mounting a glass, in which a bonding section with a high reliability can be achieved without the primer processing to the glass or the long period of time for leaving the product in the process to cure the adhesive.

Further objects and advantages of the invention will be apparent from the following description of the invention.

### SUMMARY OF THE INVENTION

A glass holder of the invention is a glass holder for fixing and supporting a glass. The glass holder of the invention includes the first holder piece; the second holder piece paired with the first holder piece and facing the first holder piece with the glass therebetween; and an attaching structure formed in at least one of the first and second holder pieces for attaching the first and second holder pieces to another member. Further, the glass holder includes a hot-melt resin attached to at least one of the first and second holder pieces to thereby bond the glass to the glass holder.

According to this structure, the glass is held between the pair of the holder pieces, and while the resin is heated by heating means to be melted, the pressure is applied to the glass holder to bond the glass thereto. Since the glass holder is separated into the two pieces, a thickness of the hot-melt resin can be freely adjusted. Therefore, when a thickness of the glass is changed, the same glass holder can hold the glass.

The hot-melt resin may be provided at only one of the holder pieces, or may be provided at both holder pieces. The first holder piece or second holder piece faces the glass in the following modes (a) and (b). In the mode (a), the holder piece without the hot-melt resin abuts against a main surface of the glass to restrain the glass. In the mode (b), the holder piece with the hot-melt resin functions as a member for fixing the glass with the hot-melt resin in between. In order to firmly fix the glass, it is desirable to provide the hot-melt resin at both holder pieces. That is, it is desirable that both holder pieces have the function in the mode (b).

When a high-frequency dielectric heating type resin is used as the hot-melt resin, only the hot-melt resin is heated without heating the entire glass holder, resulting in that the heating does not affect the glass. Also, it is preferable that the glass holder is made of an engineering plastic resin, such as a polybutylene terephthalate (PBT), an acrylonitrile-butadiene-styrene (ABS), or the like. The hot-melt resin can be easily attached and formed integrally with the glass holder made of the engineering plastic by a two-material molding. Therefore, since the hot-melt resin in a solid state is attached to the holder piece, it is not necessary to consider a method of storing and the expiration date of the adhesive.

When the hot-melt resin is heated in the bonding process and solidified by cooling down, the hot-melt resin can exhibit an inherent adhesion strength. Therefore, it is possible to eliminate a long period of time for leaving a product in process as it is, and the productivity can be improved. Further, it is not necessary to consider the dimensional accuracy of the glass holder in order to prevent the glass holder from falling down by its own weight until the adhesive is solidified. Also, the primer processing to the glass is not necessary. However, in order to obtain higher adhesion strength, the primer processing may be applied to the glass.

In the glass holder of the invention, a projection having a predetermined height can be formed at an area of the holder piece where the hot-melt is attached.

According to this structure, a space corresponding to the height of the projection is formed between the glass and the holder piece. When the pressure is applied to the glass holder as described above, without adjusting a stroke (a push-in length upon applying the pressure), the hot-melt resin in a molten state can be disposed in the space between the glass and the holder piece. Therefore, it is possible to eliminate such a risk that the glass and glass holder are brought in contact with each other too closely by having too long stroke, resulting in squeezing out all the resin. Also, the thickness of the hot-melt resin layer as the adhesive can be adjusted by the height of the projection, and any thickness of the adhesive can be formed. As a result, the necessary adhesion strength can be easily obtained, and the productivity can be improved by improving the yield.

Incidentally, it is desirable that the hot-melt resin includes a concave portion for receiving the projection, and the hot-melt resin is attached to contact the entire area of the concave portion. For example, when the hot-melt resin is attached to the holder piece by the two-tone molding, the contact between the hot-melt resin and the holder piece can be naturally achieved between the projection and the concave portion, and at other portion of the area. This attaching mode is preferable in order to improve the attaching strength of the hot-melt resin with respect to the area of the holding piece, and to conduct the two-material molding without difficulty. Further, since the hot-melt resin covers the surface of the holder piece, the surface condition preferable for bonding can be easily maintained until the hot-melt process. As a result, the bonding strength between the glass and holder piece can be further improved.

In the glass holder of the invention, the hot-melt resin may be formed of a dielectric heating adhesive resin.

In this structure, only the adhesive resin is heated for a short time by the high-frequency dielectric heating, and the adhesive resin is melted and allowed to cool down, so that the necessary adhesion strength can be obtained. Therefore, without leaving an effect of the heating on the glass, the bonding operation described above can be easily conducted in a small heating space. Namely, it is not necessary to provide a heating furnace or the like. Therefore, the glass holder of the invention has an advantage in terms of the energy consumption, and much more desirable working environment can be maintained.

In the glass holder of the invention, the attaching structure may include a nut attaching recessed section formed around a through hole in one of the first and second holder pieces.

A metal nut or the like can be fitted. later to this nut attaching section not to move easily. Then, a bolt is screwed with the nut, so that the glass holder can be attached to a roller guide as in the conventional glass holder. Therefore, according to this structure, an insert molding process in which the nut is formed integrally with the glass holder can be omitted, so that the manufacturing cost can be lowered.

A method of mounting the glass according to the invention is a method for mounting the glass by using the pair of the holder pieces. This method of mounting the glass includes a process of attaching the dielectric heating adhesive resin to at least one of the holder pieces, and a process of applying a force such that the glass is sandwiched between the holder pieces, and applying a high-frequency dielectric heating to the area where the glass is sandwiched between the holder pieces.

According to this method, the glass can be bonded with the high adhesion strength in a short time. Also, according to the method, it is not necessary to have many types of glass holders in accordance with the thickness of the glass. Further, it is not necessary to consider an expiration date of the adhesive and the method of storing the adhesive. Also, since the electric power is applied to only the necessary portion, the energy consumption can be cut down. Further, this method has such an advantage that the heating can be conducted in the small work area without the heating furnace or the like. Still further, the working environment can be easily maintained in an excellent condition.

### BRIEF DESCRIPTION OF THE DRAWINGS

FIGS. 1(a) to 1(c) are perspective views showing a glass holder according to an embodiment of the invention, wherein FIG. 1(a) is a perspective view of one of holder pieces, FIG. 1(b) is a partially sectional perspective view of the other of the holder pieces, and FIG. 1(c) is a perspective view of a nut;

FIG. 2 is a sectional view showing a state that a glass is attached to the glass holder shown in FIGS. 1(a) to 1(c);

FIG. 3 is a front view showing a state that the glass holder attached to the glass is mounted to a roller guide of an elevating and lowering mechanism;

FIG. 4 is a perspective view for explaining a conventional glass holder; and

FIG. 5 is a sectional view taken along line 5-5 in FIG. 4.

### DETAILED DESCRIPTION OF PREFERRED EMBODIMENTS

Hereunder, embodiments of the present invention will be explained with reference to the accompanying drawings.

(1) Structure of a Glass Holder

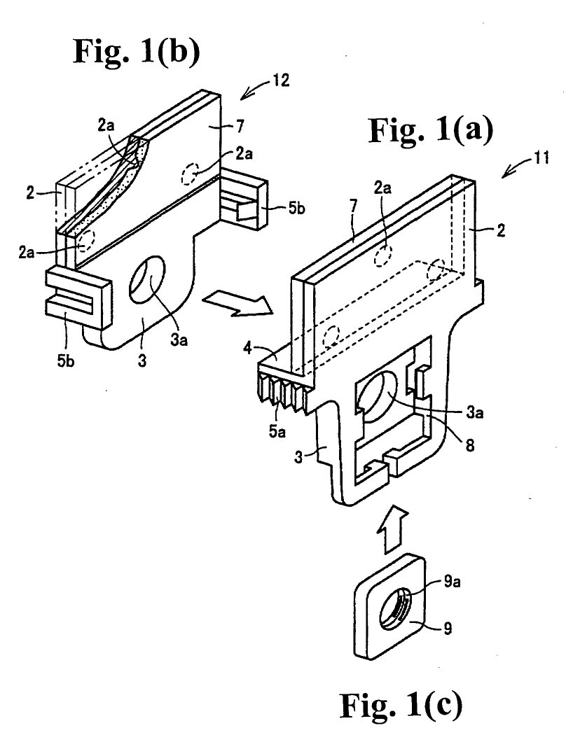

FIGS. 1(a) to 1(c) are perspective views showing a glass holder of an embodiment of the invention. FIG. 1(a) is a perspective view of one of holder pieces forming the glass holder, and FIG. 1(b) is a partially sectional perspective view of the other of the holder pieces. Also, FIG. 1(c) shows a nut to be inserted into the holder piece shown in FIG. 1(a).

In both holder pieces 11 and 12, dielectric heating adhesion resin layers 7 formed of a hot-melt resin are respectively attached to adhesion walls or areas 2 facing a glass. Also, in each of the holder pieces 11 and 12, the area 2 facing the glass is provided with three projections 2a projected toward the glass and disposed away from each other. The dielectric heating adhesion resin layer 7 is attached to the area 2 facing the glass in each of the holder pieces 11 and 12 by a two-material molding such that the dielectric heating adhesion resin layer 7 contacts projections 2a and the remaining area of the surface. Therefore, in the dielectric heating adhesion resin layer 7, recess portions are formed at positions corresponding to the projections 2a, to thereby receive the projections 2a therein. These recess portions are naturally formed at the time of the two-material molding.

One of the holder pieces, that is, the holder piece 11 shown in FIG. 1(a), is provided with a glass receiving section 4 against which an end surface of the glass abuts to thereby directly receive a load of the glass. The glass receiving section 4 may be formed at only one of the holder pieces, or may be formed at both holder pieces so that the both holder pieces directly receive the load of the glass. Also, engaging projections 5a are formed at one of the holder pieces, that is, the holder piece 11, and the other holder piece 12 is provided with projection storing or receiving sections 5b, to which the engaging projections 5a are fitted, so that the two holding pieces 11 and 12 are engaged with each other.

Further, a metal nut 9 provided with a female screw 9a is inserted into a nut attaching recessed section or nut insertion section 8 of a mounting section 3 of the holder piece 11. The female screw 9a is disposed to be coaxial to a through hole 3a formed in the mounting section 3.

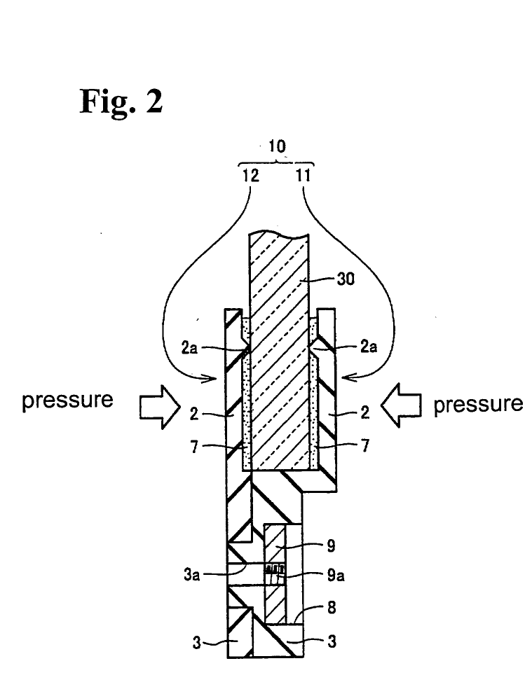

FIG. 2 is a sectional view of a glass attaching section after the bonding process is carried out. A glass 30 is bonded to the adhesion walls 2 of the holder pieces by the dielectric heating adhesion resin layers 7 respectively having a thickness equal to a height of the projection 2a of the holder piece. The adhesion layers 7, which have been hot-molten and set, firmly bond the glass and the holder pieces. In a case that the glass holder is attached to the roller guide of the elevating and lowering device, the bolt is inserted from the holder piece 12 side, and is screwed with the female screw 9a.

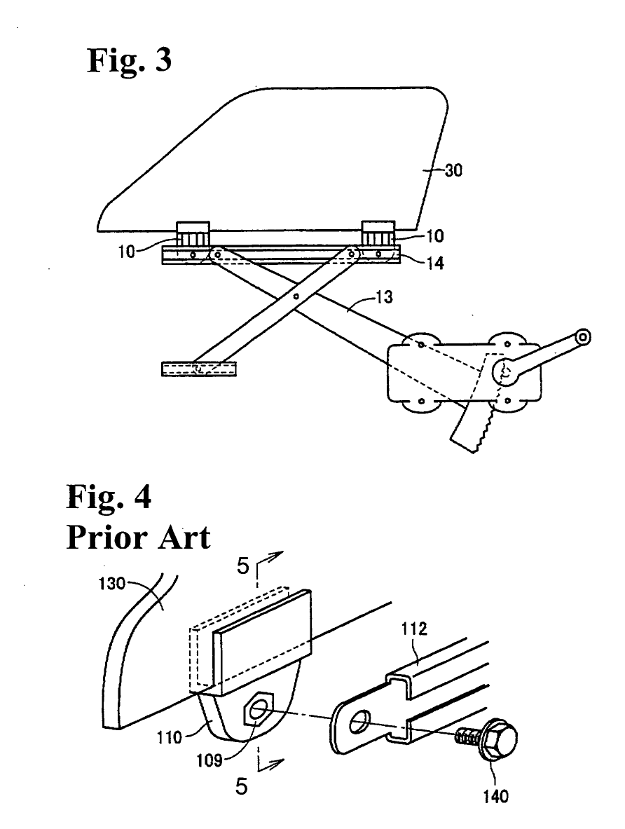

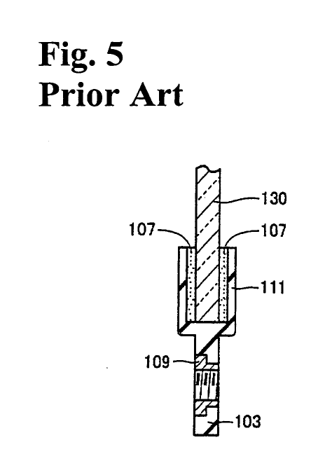

FIG. 3 shows a structural view showing a state that the side window glass 30 is attached to an elevating and lowering device 13. The glass holder 10 for holding the glass 30 is attached to a roller guide 14 forming a part of the elevating and lowering device 13. By using the glass holder structured as described above, the glass can be firmly attached to the elevating and lowering device with good productivity.

(2) Hot-Melt Resin

Although the dielectric heating adhesion resin is used as the hot-melt resin in the embodiment of the invention, the hot-melt resin can be any resin in a large sense as long as the resin is in a solidified or set state when the resin is once molten by heating and cooled down to a room temperature. However, as the dielectric heating adhesion resin can be easily heated with good workability, the dielectric heating adhesion resin is suitable to be used in the glass holder.

The dielectric heating adhesion resin used in the invention is a high-frequency adhesion resin composition mainly composed of a resin, in which a polyolefin-based resin with a melting point of 80° C. to 200° C. includes 1 to 30 volume % of a dielectric substance with a volume resistivity of 10⁻² Ω·cm or less such that the dielectric loss tangent of the resin is 0.03 or more at the frequency of 40 MHz. Preferably, the resin is a high-frequency adhesion resin composition in which the dielectric loss tangent is 0.05 or more. More: preferably, the resin is a high-frequency adhesion resin composition that includes 5 volume % or more of a conductive material with a volume resistivity of 10⁻⁴ Ω·cm.

As the conductive material used in the dielectric heating adhesion resin, iron, copper, silver, carbon fiber, carbon black or the like having a volume resistivity of 10⁻²Ω·cm or less is used. Among these materials, the iron-based conductor and the carbon fiber are preferable in view of an effect to the resin and an economical reason. The volume resistivity is preferable to be 10⁻⁴ Ω·cm or less, and the conductive material is not specifically limited, and can be so-called iron, α-iron, β-iron, γ-iron, and carbon steel. The content of the conductive material is 1 to 30 volume %, and preferably, the content needs to be 5 to 25 volume %. Especially, when the content of the conductive material is 7 volume % or more, there can be increased the effect that the dielectric heating adhesion resin is heated by the dielectric heating.

If the content of the conductive material is less than 1 volume %, the heating becomes deficient, and it takes a long time to reach a temperature for enabling the adhesion, so such a resin is not suitable. On the other hand, if the content of the conductive material is more than 30 volume %, the adhesion strength is deteriorated, so such a resin is also not preferable. Also, a form of the conductive material can be powder, needle, scale, or mesh, and is selected from these forms in accordance with a form of the object to be bonded. It is preferable that the conductive material is in the powder form since the powder form can be adjusted to any forms of the object to be bonded. In a case that the conductive material is in the powder-form, the needle-form or the scale-form, the conductive material is mixed or kneaded into the resin in many cases. In a case that the conductive material is in the mesh-form, the conductive material is laminated or provided by an insert molding.

In a case that the conductive material is kneaded, it is preferable that the heating element has a size of 60 mesh pass. Although a reason is not clear yet, by including 1 volume % or more of the conductive material, or especially, 5 volume % or more of the conductive material to lower the volume resistivity thereof, the dielectric power factor upon imposing the high-frequency voltage is increased, so that the dielectric loss factor, which is a product of the dielectric power factor multiplied by the dielectric constant, is dramatically increased. When the high-frequency voltage is applied, if the dielectric loss factor is large, the heating amount is high, so that a programming rate or a heating rate is accelerated. Therefore, the hot-melt type adhesive can be melted in a short time, so that the steps of manufacturing thereof can be shortened.

In the induction heating, an electromagnetic induction causes an eddy current in a conductor as a member to be heated, thereby generating heat by the resistance. On the other hand, in the dielectric heating, a voltage is applied to a non-conductor, and an internal friction heat generated by the polarization is utilized. The internal friction is measured as the dielectric loss tangent. It has not been known that when a conductor having very small resistivity and very small dielectric loss tangent of 0.0001 or less is compounded in a resin having the dielectric loss tangent of 0.01 to 0.03, for example, the polyolefin-based resin, the dielectric loss tangent of the compounded resin becomes more than 0.03.

Also, from the adhesion property point of view, for the dielectric heating adhesive resin, it is preferable that the resin having the melting point of 80° C. to 200° C., for example, the polyolefin-based resin, is mainly formed of a copolymer thereof. From the adhesion strength at a high temperature point of view, the melting point needs to be 80° C. or higher, or preferably 90° C. or higher. However, if the melting point is 180° C. or higher, or especially higher than 200° C., it takes long time to melt the adhesive, so that the resin having the melting point of higher than 200° C. is not suitable. In terms of bonding to the glass, in order to improve the adhesion property, it is preferable to include a coupling agent having a silanol group and a functional group attached to a chain end of the resin or through modification. As for the coupling agent, γ-aminopropyl-triethoxysilane, β(3,4 epoxycyclohexyl) ethyltrimethoxysilane, γ-glycidexysilane-trimethoxysilane, γ-methacryloxypropyl-trimethoxysilane, or N·β(aminoethyl) γ-aminopropyl-trimethoxyxilane can be used.

The polyolefin-based resin is preferably formed of one or more resins selected from a polypropylene copolymer type resin, a polyethylene copolymer type resin, an ethylene-propylene copolymer resin, an ethylene-propylene-diene type resin, and an ethylene-α-olefin type resin. Also, in order to improve the adhesion property, it is preferable that the resin is polymerized with 3 to 50 mole % of vinyl acetate, methylmethacrylate, ethylacrylate, butylacrylate, methacrylic acid, acrylic acid, methacrylate or the like as a monomer component. Further, it is especially preferable that the resin is polymerized or grafted with a monomer including carboxylic acid anhydride group, epoxy group, hydroxyl group, and isocyanate group. Also, polymerization with an unsaturated carboxylic monomer or glycidylmethacrylate, or graft modification with maleicanhydride is preferable. By introducing these functional groups, the silanol compounds can be stabilized, and the adhesion property of the reinforced thermoplastic resin can be improved.

In the present invention, a member to be bonded, to which the dielectric heating adhesion resin is used, is formed of a material forming the glass holder, for example, a resin, especially an engineering plastic, and a glass. A material forming the glass holder can be ceramics, metal, or the like other than the resin, and not limited thereto. As the resin used for the material forming the glass holder, either of a thermosetting resin and a thermoplastic resin can be the member to be bonded. In a case of using the dielectric heating adhesion resin described above, since only the adhesion layer is selectively heated, the thermoplastic resin having the melting point of 200° C. or less can be used as the member to be bonded. In order to increase the adhesion strength, it is preferable that the functional group is introduced into the polyolefin-based resin in accordance with the member to be bonded.

In the dielectric heating adhesion resin, the conductive material is mixed in advance into a molten resin having the melting point of 80° C. to 200° C., for example, a polyolefin type resin, by an extruder, kneader, or roll. Alternatively, after the resin is formed into a sheet form, the conductive material is laminated or sandwiched, or a mesh-like heating element is inserted into a metallic die to mold by an injection molding. A type of extruder, kneader, or roll and mixing conditions used in the aforementioned process are not limited to specific ones.

Also, conventional additives, an anti-hydrolysis agent, or a pigment can be added to the dielectric heating adhesion resin composition. As a heat stabilizer, a hindered-phenol type, a thioether type, a phosphite type, and a combination of these stabilizers can be used. As a weathering agent, carbon black, benzophenone, a triazole type, and a hindered-amine type can be used. Further, as the anti-hydrolysis agent, carbodiimide, bisoxazoline, an epoxy, and an isocyanate compound can be used. As the pigment, a heat resistant pigment for a polyolefin type resin can be used.

(3) Bonding Method

Next, steps of bonding the glass will be explained. Firstly, the engaging projections 5a and the projection storing sections 5b of the holder pieces shown in FIGS. 1(a) and 1(b) are engaged with each other. Then, the glass is disposed between the holder pieces to be sandwiched. At this time, the nut 9 may be inserted into the nut insertion section 8, or not. The glass is sandwiched between the holder pieces, and the adhesion resin layer 7 is heated by the high-frequency dielectric heating. At this time, the holder piece, the dielectric heating adhesion resin layer, the glass plate, the dielectric heating adhesion resin layer and the holder piece are laminated in this order.

In the high-frequency dielectric heating, a pressure is applied between an upper electrode and a lower electrode in a direction toward the glass plate, and a high frequency voltage is applied from a high-frequency oscillator between the upper and lower electrodes, to thereby generate the dielectric heating. A temperature of the adhesion composition is increased with time, and when the temperature of the adhesion composition exceeds the melting point thereof, the adhesion composition flows and adheres. Since the adhesive resin is in the molten state or in the state closer to the molten state, the adhesive resin is softly and easily pushed, and a part thereof is excluded to outside by a portion of the narrowed space. However, since the holder piece is provided with the projections 2a, when the distal ends of the projections 2a are in contact with the glass, the holder piece and the glass do not get closer to each other further. Therefore, the adhesive resin layer having a thickness corresponding to the height of the projection 2a is disposed between the holder piece and the glass, and can contribute to the adhesion.

Therefore, it is desirable that at least three projections 2a are arranged not in a straight line. However, it is not indispensable to provide three or more projections, and any number of projections can be provided as long as the space between the glass and the holder piece can be maintained without difficulty. For example, there can be provided one projection if the projection has a flat apex with more than a predetermined area.

In the bonded state, the high-frequency voltage is disconnected, and the adhesion resin is allowed to cool down as is, or cooled by air. The adhesion composition of the present invention is bonded at a temperature higher than the melting point thereof, and the bonded assembly is used at a temperature lower than the melting point.

When the high-frequency voltage is applied to the dielectric heating adhesion layer, only the adhesion layer is heated by the high-frequency dielectric heating. Therefore, it is not necessary to process the entire member to be bonded in a heating furnace, especially effective for a large member to be bonded. Also, since only the adhesive layer is heated selectively, the present invention is effective in a case of assembling a product having a member to be bonded with low heat resistance.

### Embodiment

Next, the adhesion strength will be explained in detail with reference to the embodiment.

(a) Preparing an Adhesive Pellet:

As shown in Table 1, a polyolefin type hot-melt adhesive having a dielectric loss tangent of 0.027 and a conductive powder are mixed in advance. Regarding the melting point of the resin, the melting point of PO-1 is 105° C., and the melting point of PO-2 is 120° C., and both melting points are within the range of 80° C. to 200° C. The included conductive material in the resin is in the range of 1 to 30 volume %. Then, the resin and the conductive powder are supplied to a hopper of a twin screw extruder PCM30φ (manufactured by “IKEGAI TEKKOSHA”), in which temperatures of barrels from the hopper side are controlled at 170° C.-180° C.-180° C., and are melted and mixed at a screw speed of 60 rpm. Thereafter, strands are cooled in a water bath, and cut to obtain pellets of the hot-melt adhesive including the conductive material.

(b) Preparing a Test Piece:

The adhesive pellets are thrown into an injection molding machine in which temperatures of barrels from the hopper side are controlled at 180° C.-200° C.-180° C. Then, the adhesive is injected into a test piece mold, in which a temperature is controlled at 40° C., to thereby obtain adhesive plates of 100×100×1 mm and 100×100×3 mm. These adhesive plates are the hot-melt resins before attached to the holder pieces 11, 12 shown in FIGS. 1(a) and 1(b). Also, pellets of 30 weight % glass fiber reinforced polybutylene terephthalate (EMC430 manufactured by TOYOBO CO., LTD.), which have been dried at 140° C. for three hours, are thrown into the hopper of the injection molding machine, in which temperatures of the barrels from the hopper side are controlled at 250° C.-260° C.-260° C., to thereby mold a type 1 tensile test specimen described in ASTM D-638.

(C) Adhesion Strength:

The test piece formed and obtained by the aforementioned method described in (b) is cut at the center in the longitudinal direction. These pieces correspond to the holder pieces before the adhesive layers are attached. The adhesive layer, which is cut into a size of 12.7×25.4×1.0 mm from the adhesive plate of 100×100×1 mm obtained as described in (b), is laminated onto a straight portion 12.7×25.4 mm of the test piece. These lap members, that is, the members corresponding to the holder pieces, are set linearly on both sides of a glass plate having a dimension of 33×100 ×3 mm. Then, in a state that a pressure of 2 kgf is applied in a 20 mφ air cylinder, these members are heated for one minute by a high-frequency dielectric heating device (manufactured by PEARL KOGYO CO., LTD.), and cooled in air for one minute to obtain a specimen for the adhesion strength test. This state corresponds to the state in which the glass is sandwiched between the two holder pieces and bonded. Although clamping sections are located at the same side as the adhesive sections in the glass holder shown in FIGS. 1(a) to 1(c) and FIG. 2, the clamping sections are positioned to clamp the adhesive sections in order to conduct the tensile shear test.

The test piece for the evaluation has been left for five hours in the laboratory in which the temperature is adjusted at 23° C. and the relative humidity (RH) is 50%. The test piece molded by EMC430 and bonded at both ends of the glass plate are set in a chuck of the universal tension tester UTMI (manufactured by “ORIENTIC KABUSHIKI KAISHA”) having an environmental chamber in which the temperature is adjusted at 50° C., and the tensile shear test is carried out at a rate of 5 mm/minute to measure the adhesion strength at 50° C.

(4) Dielectric Property:

A test piece having a dimension of 8×8 mm cut from the plate with a thickness of 3 mm formed in the above step (b) is clamped and set between conductor terminals having a terminal area Ds of 5 cm² and connected to a high-frequency power circuit (manufactured by PEARL KOGYO CO., LTD.). A high frequency charge Q at a frequency of 40 MHz is applied, and an electrostatic capacity Cs and a dielectric loss tan δ are measured from a potential difference V between the terminals. With a condition that the dielectric constant ε₀ in the vacuum state is 8.85×10⁻¹⁴ F/cm, the dielectric loss factor ε·tan δ is determined by the following formula (1).

ε·tan δ=Cs×Ds/(ε₀·S) (1)

Examples 1 to 12 of the invention: (the dielectric loss tangent and the compositions thereof are within the aforementioned recommended ranges)

Premixed mixtures having the compounding ratios shown in Table 1 are compounded as described above, to thereby form the high-frequency adhesive plates.

TABLE 1
Examples of the Invention

| | | | | | | | | | | |
|---|---|---|---|---|---|---|---|---|---|---|
| No. 1 | No. 2 | No. 3 | No. 4 | No. 5 | No. 6 | No. 7 | No. 8 | No. 10 | No. 11 | No. 12 |

Composition (vol. %)

| | | | | | | | | | | | |
|---|---|---|---|---|---|---|---|---|---|---|---|
| PO-1 | 97.5 | 95 | 92 | 92 | 92 | 92 | — | 97.5 | 95 | 92 | 97.5 |
| PO-2 | — | — | — | — | — | — | 92 | — | — | — | — |
| Fe100 | 2.5 | 5 | 8 | — | — | — | 8 | 2.5 | 5 | 8 | 2.5 |
| (Conductive | | | | | | | | | | | |
| Material) | | | | | | | | | | | |
| Fe200 | — | — | — | 8 | — | — | — | — | — | — | — |
| (Conductive | | | | | | | | | | | |
| Material) | | | | | | | | | | | |
| Cu100 | — | — | — | — | 8 | — | — | — | — | — | — |
| (Conductive | | | | | | | | | | | |
| Material) | | | | | | | | | | | |
| CF | — | — | — | — | — | 8 | — | — | — | — | — |
| (Conductive | | | | | | | | | | | |
| Material) | | | | | | | | | | | |
| Oscillating | 1 | 1 | 1 | 1 | 1 | 1 | 1 | 5 | 5 | 5 | 20 |
| time (minute) | | | | | | | | | | | |
| Dielectric loss | 0.032 | 0.055 | 0.24 | 0.26 | 0.22 | 0.19 | 0.31 | 0.032 | 0.055 | 0.24 | 0.24 |
| tangent | | | | | | | | | | | |
| Dielectric loss | 1.9 | 3 | 72 | 76 | 48 | 40 | 71 | 1.9 | 3 | 72 | 1.9 |
| factor (cm⁻¹) | | | | | | | | | | | |
| Adhesive | 1.1 | 3.1 | 4.6 | 4.1 | 3.9 | 5.5 | 5.1 | 1.9 | 6 | 4.5 | 6.8 |
| strength | | | | | | | | | | | |
| (MPa) | | | | | | | | | | | |

PO-1: Silane modified G197 (Polyolefin type, manufactured by KUREHA ELASTOMER CO., LTD.) melting point; 105° C.
PO-2: Silane modified G1019 (Polyolefin type, manufactured by KUREHA ELASTOMER CO., LTD.) melting point; 120° C.
Fe100: ASC100 (Iron powder, manufactured by Höganäs AB) average particle diameter; 100 micron, volume resistivity; 1.4 × 10⁻⁶ Ω-cm
Fe200: KIP3100 (Iron powder, manufactured by Kawasaki Steel Corp.) average particle diameter; 200 micron, volume resistivity; 1.6 × 10⁻⁶ Ω-cm.
Cu100: CE-6 (copper powder, manufactured by FUKUDA METAL FOIL & POWDER CO., LTD.) average particle diameter; 100 micron, volume resistivity; 1.7 × 10⁻⁶ Ω-cm.
CF: HTA (carbon fiber, manufactured by TOHO RAYON CO., LTD.) cut length; 3 mm, volume resistivity; 1.5 × 10⁻³ Ω-cm.

The dielectric loss tangent and the dielectric loss factor are respectively measured for these plates. Also, the glass and the glass fiber reinforced polybutylane terephthalate resin molded as the member to be bonded are bonded by the high frequency dielectric bonding with the oscillating time of 1 minute or 5 minutes, and the adhesion strength thereof is measured.

Reference examples for comparison: (the dielectric loss tangent and the composition of the adhesive are outside the recommended range)

Premixed mixtures having the compounding ratios shown in Table 2 are compounded to obtain plates by the same methods as in the embodiment of the invention, and the adhesion strength thereof is measured.

TABLE 2

| | | Reference examples for comparison | | | |
|---|---|---|---|---|---|
| | | No. 1 | No. 2 | No. 3 | No. 4 |
| Composition | PO-1 | 100 | 100 | 99.5 | 99.5 |
| (volume %) | PO-2 | — | — | — | — |
| | Fe100 | — | — | 0.5 | 35 |
| | Fe200 | — | — | — | — |
| | Cu100 | — | — | — | — |
| | CF | — | — | — | — |

| | | | | |
|---|---|---|---|---|
| Oscillating time | 1 | 20 | 20 | 1 |
| (minute) | | | | |
| Dielectric loss | 0.027 | 0.027 | 0.027 | 0.16 |
| tangent | | | | |
| Dielectric loss | 1.4 | 1.4 | 1.6 | 55 |
| factor (cm⁻¹) | | | | |
| Adhesion strength | 0 | 0 | 0 | 0.2 |
| (Mpa) | | | | |

For some of the reference examples, the adhesive property is evaluated by changing the oscillating time as the high-frequency heating time. As evident from the comparison between the adhesion strengths in Table 1 and Table 2, every example of the invention exhibits the high adhesion strength higher than 1.1 MPa. On the contrary, for the reference examples, only the example No. 4 exhibits the adhesion strength of 0.2 MPa, and other reference examples can not exhibit a finite adhesion strength. Again, the hot-melt adhesive set in a short period of time obtains the high adhesion strength according to the present invention. Therefore, it is possible to proceed to the next process immediately after the glass is bonded to the glass holder without leaving the product in the process as is for a long time. Therefore, the glass can be bonded to the glass holder with the high productivity.

Further, in this holding structure, since the holder pieces are separate, even if the thickness of the glass is changed, the bonding can be carried out by applying the pressure. Also, since the thickness of the dielectric heating adhesion resin layers 7 can be adjusted freely by the height of the projections formed in the holder piece, the optimum thickness of the adhesive layer can be secured easily. Therefore, irrespective of the change in the thickness of the glass, the high adhesion strength can be achieved. Further, it is not necessary to control the dimension of the glass holder and the storage of the adhesive.

Although the invention has been explained with reference the aforementioned embodiments, the embodiments are merely examples, and the range of the invention is not limited to the embodiments of the invention. For example, the hot-melt resin is not limited to the dielectric heating adhesive resin, and can be other types of the hot-melt resin. The range of the invention is disclosed by the claims, and the present invention includes all of the modifications within the range equivalent to the claims.

By using the glass holder and the method of bonding the glass according to the present invention, the primer processing applied to the adhesive surfaces of the glass and the holder or the long period of leaving the product in the process as is for setting the adhesive is not required, and the adhesion sections with high reliability can be achieved. Therefore, the window glass of the automobile can be firmly attached to the elevating and lowering device with the high productivity, and the attaching structure excellent in the durability can be achieved.

The disclosure of Japanese Patent Application No. 2001-317673 has been incorporated in the application.

While the invention has been explained with reference to the specific embodiments of the invention, the explanation is illustrative and the invention is limited only by the appended claims.

What is claimed is:

1. A method of mounting a glass to a glass holder, comprising:
attaching a hot-melt resin to at least one of holder pieces for forming the glass holder,
sandwiching the glass between the holder pieces and applying a force therebetween, and
applying a high-frequency dielectric heating to an area where the glass is sandwiched between the holder pieces to melt and adhere the hot-melt resin to the glass.

2. A method of mounting a glass according to claim 1, wherein said hot-melt resin is made of a dielectric heating adhesive resin.

3. A method of mounting a glass according to claim 1, wherein said hot-melt resin is attached to one side of each of the holder pieces contacting the glass by molding.

4. A method of mounting a glass according to claim 3, wherein each of the holder pieces is formed by molding to have projections at the one side for holding the hot-melt resin and the glass.

5. A method of mounting a glass according to claim 3, wherein an engaging projection of one of the holder pieces is engaged with a receiving section of the other holder piece to form a space therebetween, to which the glass is placed to sandwich the glass.
